(19) United States
(12) Patent Application Publication
(10) Pub. No.: US 2007/0051914 A1
(43) Pub. Date: Mar. 8, 2007

(54) Emergency fire-stop

(76) Inventors: Jeremias Ayala, Tampa, FL (US); Mandi Killette Ayala, Tampa, FL (US)

Correspondence Address: Jeremias or Mandi Ayala, 9310 N. 27th St., Tampa, FL, 33612, US

(21) Appl. No.: 11/219,547

(22) Filed: Sep. 6, 2005

(51) Int. Cl. A62D 1/00

(52) U.S. Cl. 252/2

(57) ABSTRACT

This invention is an all-natural, non-toxic, liquid fire extinguisher that can be used to extinguish small category A and B fires. It is sprayed onto the fire site using an easy to use spray container. It results in little or no mess and is even safe if swallowed.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

Emergency Fire-Stop is related to the field of compositions. It is a liquid solution formulated for extinguishing fires.

Grease fires are a massive threat to both commercial and private kitchens all over the world. There are two reasons for this. One reason is that some methods of cooking require the use of and often the production of substances like oil, grease, and fat, which are usually heated. This causes them to become highly flammable. The other reason that grease fires are so prevalent in this realm is that many employees of these establishments, as well as private homeowners, do not know how to properly extinguish these fires. If the wrong method is used, such as putting water on a grease fire, the effects can be quite devastating.

Most kitchens rely on the standard fire extinguisher to put out small grease fires. These extinguishers are often not used or misused for several reasons. Many people are afraid to use them because they are difficult to operate. Even restaurant employees have been known to spray into their own faces because they have aimed it in the wrong direction. Another reason people sometimes avoid the traditional fire extinguisher is because it makes a huge mess. The kitchen must then be cleaned up and the food that was cooking is ruined. People in private homes often don't know where it is because it must be kept out of the reach of children.

The need therefore exists for a fire extinguisher of small fires that is easy enough for even a child to use, that can be conveniently located because it is not harmful-even if swallowed by children, and that won't cause a mess or ruin the food.

### BRIEF SUMMARY OF THE INVENTION

The present invention is the formulation of a compound that is an all-natural non-toxic liquid solution that can be used to extinguish all small category A and B fires. It can be sprayed directly onto the fire in an ordinary trigger spray bottle or canister and is not messy to use.

### BRIEF DESCRIPTION OF THE SEVERAL VIEWS OF THE DRAWING

Not Applicable

### DETAILED DESCRIPTION OF THE INVENTION

The present invention is a solution that is safe and easy to use in putting out small category A and B fires, such as wood fires, charcoal fires, or even grease fires. This invention is different from present fire extinguishers in many ways.

First, this invention is in liquid form so it can be easily sprayed using a traditional trigger spray bottle for private use and a larger canister sprayer for commercial use. This eliminates the problem of traditional extinguishers which are in a foam form and whose canisters are more difficult to operate. Additionally, the ease of its use and its liquid form result in the elimination of the mess that is left after using a traditional fire extinguisher. Not only is there no mess, but the heating element, such as a stove burner, is left cleaner than before.

Another difference between this solution and other small fire extinguishers is that this one is safe and non-toxic because it is made of lemon juice, salt, and food coloring. It is 98% lemon juice and 2% salt. Even if children drank it, it would not be harmful. Thus, unlike other extinguishers, after being sprayed with this invention, the food can often still be consumed. An individual may feel that it would not be to his/her taste afterwards, but it will definitely not be harmful. The process for mixing the solution is as follows:

First, add one tablespoon of salt for every quart of lemon juice. Next, add food coloring to give product color. Mix well. The solution is then poured into a sprayer container. It would prove beneficial to use a red container, which is the color of most fire extinguishers to assist the consumer in associating the product with fire extinguishers. The solution is directly sprayed onto the fire. It is noted that this product will only be effective on small Category A and B fires due to the small container that will be used to administer it.

Although this invention has been described in conjunction with specific embodiments, it is obvious that many alternatives or variations may become apparent to those individuals with the required capability. However, it is intended that this invention include all such modifications the appended claim.

What is claimed as new and desired to be secured by a patent is:

1. A method of using a solution comprised of:
(i.) lemon juice and
(ii.) a preservative substance such as salt
turbulating the dilution
applying a sufficient amount of the solution over the surface of the fire site to extinguish small category A and B fires.
